(19) United States
(12) Patent Application Publication
(10) Pub. No.: US 2024/0261602 A1
(43) Pub. Date: Aug. 8, 2024

(54) SAFETY BREATH

(71) Applicant: KRIS McKENNA, Skowhegan, ME (US)

(72) Inventor: KRIS McKENNA, Skowhegan, ME (US)

(21) Appl. No.: 18/105,774

(22) Filed: Feb. 3, 2023

(51) Int. Cl. A62B 7/02; A62B 3/00; A62B 9/00; A62B 9/02; A62B 9/06

(52) U.S. Cl. CPC A62B 7/02; A62B 3/00; A62B 9/00; A62B 9/02; A62B 9/06

(57) ABSTRACT

The present invention relates to novel, handheld devices for delivering breathable gas. In particular, the present invention relates to novel, handheld devices for delivering lifesaving oxygen to a user when during an emergency such a in a smoke-filled room during a fire, underwater during an automobile accident, a toxic chemical spill and the like.

### FIELD OF INVENTION

The present invention relates to novel, handheld devices for delivering breathable gas. In particular, the present invention relates to novel, handheld devices for delivering lifesaving oxygen to a user when during an emergency such a in a smoke-filled room during a fire, underwater during an automobile accident, a toxic chemical spill and the like. The device is designed to give 6-10 full breaths and be disposable after use.

### BACKGROUND

In many emergency situations, a person in that situation needs to hold their breath while they remove themselves from the emergency area. On average, under normal conditions, a normal person can hold their breath between about 30-90 seconds. In emergency situations where stress level s are elevated a person cannot hold their breath as long. In those situations where a person cannot breath or there is not enough time to level the emergency area with only their current inhaled breath, there is only a short time to respond. Often only a few minutes are needed to save one's life but there is often not enough air for the person to last the few minutes needed before succumbing. Such emergencies include fires wherein most people die from smoke inhalation and not the actual fire. When it comes to house fires, many people think it's the blaze itself that kills people. But more often than not, the actual cause of death is smoke inhalation. Most of the deaths from a fire in a high-rise apartment is the result of smoke inhalation.

According to the most recent data from the National Center for Health Statistics, smoke inhalation is the most common cause of death in house fires. In 2019 alone, it accounted for 38 percent of all house fire deaths.

When smoke moves into the lungs, it penetrates the respiratory system's protective filters, sticking there. What makes this so dangerous are the toxic gases, such as carbon monoxide, which can replace oxygen in the bloodstream.

In situations where cars enter water and become submerged, for example if the car runs off the road into a pond, river, during flooding, or other water submersing situations, a person needs time to break through the window glass when a door won't open and get to the surface of the water. Again, often only a few minutes can mean the difference between life and death. National Highway Traffic Safety Administration reports that an average more than 300 vehicle occupants die in submersion type crashes each year, Florida leads the nation in such deaths.

Other emergency situations include noxious chemical spills, such a, for example, HCl spills, or train derailments of cars carrying chlorine gas. These situations can be very deadly if there is no emergency breathing devices readily available to allow persons exposed to the toxic fumes to vacate the area immediately.

As stated above, in the above emergency situations, a person needs only a few minutes to escape and get to safety. Holding one's breath for a prolonged length of time may not be possible while getting to safety. The average person can hold their breath for 30-90 seconds. This time can increase or decrease due to various factors, such as smoking, underlying medical conditions, or breath training. When in an emergency, a lot of energy is used to get to safety as well as the energy expended in panic, hyperventilation and the like, so that length of time may be reduced from that of a non-emergency situation.

Thus, there are continuing needs for life saving equipment devices and procedures to reduce the number of deaths accountable to lack of the ability to breathe, even for a short time.

### BRIEF DESCRIPTION OF THE FIGURES

FIG. 1 shows an oblique view of one embodiment of the current disclosure including a cylinder 10 filled with compressed breathable gas.

FIG. 2 shows a cross-section view of one embodiment of the current disclose including a cylinder 40 and an actuator 44.

### SUMMARY OF THE DISCLOSURE

Disclosed and claimed herein are Emergency Breathing Devices. The devices comprise a container which stores air or oxygen under pressure.

In a first embodiment, disclosed and claimed herein in is a breathing device for use in emergencies, comprising a cylinder filled with compressed, breathable, gas, suitable for between 6-10 full breaths, wherein the cylinder is a disposable, non-refillable cylinder, a mask-less mouth delivery component in communication with the cylinder configured to be inserted into the mouth of the user when in use, and a component for selectively permitting breathable gas-flow from the cylinder through the mouth delivery component to the target user, wherein the device is configured to be handheld and portable when in use.

In a second embodiment, disclosed and claimed herein is the breathing device of the above embodiment wherein the component for selectively permitting breathable gas-flow is an actuator configured to release a flow of breathable gas from the cylinder to and through the mouth delivery component when engaged and to stop the flow of breathable gas when the activator is disengaged.

In a third embodiment, disclosed and claimed herein are the breathing devices of any of the above embodiments wherein the breathable gas is comprised of between 21% oxygen and 100%, medical grade oxygen.

In a fourth embodiment, disclosed and claimed herein are the breathing devices of any of the above embodiments further comprising a container containing the cylinder with the compressed gas, the mask-less mouth delivery component and the activator.

In a fifth embodiment, disclosed and claimed herein are the breathing devices of any of the above embodiments, further comprising at least one battery-powered LED light configured to illuminate the surroundings of a user, a battery powered smoke detector, a battery compartment to house a battery, a belt clip configured to carry the device on a user's clothing, one or more magnets configure to allow the device to be mounted on metal, a glass breaking component comprised of at least one hardened, sharp and heavy carbon steel point capable of breaking out through a car window in an emergency, or a razor-sharp stainless steel seat belt cutter configured to cut a seat belt completely through, or any combination thereof.

### DETAILED DESCRIPTION OF THE DISCLOSURE

As used herein, the conjunction “and” is intended to be inclusive and the conjunction “or” is not intended to be inclusive unless otherwise indicated. For example, the phrase “or, alternatively” is intended to be exclusive.

As used herein, the terms “having”, “containing”, “including”, “comprising”, and the like are open ended terms that indicate the presence of state elements or features, but do not preclude additional elements or features. The articles “a”, “an”, and “the” are intended to include the plural as well as the singular, unless the context clearly indicates otherwise.

Disclosed and claimed herein in is a breathing device for use in emergencies. The device is designed to hard held and readily portable and is comprised of a cylinder filled with compressed, breathable, gas. The cylinder is designed to be small enough to hold in a person's hand, such as, for example, 3-4 inches in length with a diameter of approximately 1 inch. In other embodiments of the current disclosure the cylinder may be smaller in length such as, for example, 2 inches and larger in diameter such as for example 1.5 inches. The size of the cylinder of the current disclosure may be chosen depending on the intended use and amount of breaths the devices is intended to deliver. For example, in an emergency where a person needs to escape a burning, smoky building, more breaths may be required and thus the cylinder used for this emergency application would be larger than 4 inches in length and larger that 1.5 inches in diameter. The cylinder may be made of any metal well known in the industry to hold compressed gases, such as, for example, stainless steel and the like.

In some applications such as, for example, for cars that have been submerged due to an accident, the cylinder may be rated to deliver 2-10 full breaths, while for smoky building applications the cylinder may be rated to deliver 50-100 breaths.

The cylinder is designed for a single use and to be disposable and not refillable. After use, the cylinder is discarded, and a new cylinder can be inserted into the device.

The breathable gas held in the cylinder may be air, generally containing 20% oxygen, or 100% medical grade oxygen, or any gas with a percentage of oxygen between 20% and 100% provide that the other gases in the mix are also breathable such as, for example, carbon dioxide. The pressure in the cylinder may be between 700 to 850 psi, but may be chosen higher or lower depending on the emergency application.

The devices of the current disclosure are comprised of a mark-less mouth delivery component in communication with the cylinder and configured to be inserted into the mouth of the user when in use. The use of masks in an emergency adds one more level of concern and complexity in that the mask must fit readily around the mouth area and be sealed such that no extraneous unwanted materials may enter the mask and thus into the lungs of the user. For example in an underwater emergency the mask must be fitted so that no water enters. Likewise in a smoke emergency the mask must fit so that no smoke enters the mask. The mask-less mouth delivery system of the current disclosure may be a hollow pipe which is inserted into the mouth with the users lips forming a seal around the pipe when in use and thus allowing delivery of the breathable gas directly into the user's air passage.

The devices of the current disclosure are further comprised of a component which selectively permits breathable gas to flow from the cylinder to the mask-less delivery system and directly into the user's mouth. The component may be an actuator configured to be activated by the user and may be, for example, a push button that releases the breathable gas which is held under pressure in the cylinder allowing the gas to flow as well as stopping the flow when released, the user thus having control of the gas flow time and frequency of use. Other components for releasing gases under pressure are well known in the art and are useful in the current disclosure.

The devices of the current disclosure comprise a mouthpiece which is operationally connected to the container and configured to fit into the mouth allowing the lips to form a sealed position which only allows gas to enter from the container into the mouth during use. The device also comprises an actuator which is operationally connected to the container and the mouthpiece. The actuator comprises a manual component which allows the pressurized air or oxygen to be discharged from the container to and through the mouthpiece on demand. The manual component is configured to allow discharge on demand when the user operates the component and stops the discharge when the manual component is released.

The current device is designed to be readily available and easily used. In one method of use, the user holds their breath for as long as possible, then exhales the spent breath. The user puts the mouthpiece of the device into their mouth and presses the manual component to release the compressed air, and inhales the air, and holds their breath again, releasing the manual component to stop air flow. When the person needs air again, the process is repeated. In this manner, assuming a 45 second time of holding one's breath, the user can gain 5-10 minutes of air/oxygen which could mean the difference between life and death, particularly when the person only needed a few breaths of air to survive.

In other embodiments the gas cylinder may contain enough air for anywhere from 5 breaths or 100 breaths depending on the size of the cylinder and the device.

The device is configured to be handheld during use, lightweight, easily portable, and easy to use.

The discharge of air is initiated by the user on demand by the use of a finger or a mouth movement engaging the actuator. The flow only occurs when the finger or mouth is engaged or other user-initiated configurations. The device is configured to stop the flow of air when the finger is removed or when the device is removed from the mouth. In this manner the user has complete control over the release of the air or oxygen. The device does not have a continuous flow, nor is the air discharge preprogrammed to deliver burst of air. The device is configured for on-demand delivery of the air as determined by the user. In this configuration air usage is efficiently delivered and air that is released that is not used for breathing is kept to a minimum.

The device is configured to be handheld during use and remain in the user's hand during continuing usage. The device is configured to be readily identifiable and available for use in an emergency, such as, for example, be brightly colored, be photoluminescent, be hanging from a wall, a car interior, a boat interior, an airplane interior, and the like.

The device does not have decorations that help it to blend into the background, but instead, like a fire extinguisher, stands out in order to be readily identifiable and is readily for use, and in confusion and emotions of an emergency would be readily accessible. Decorations hide the device in an emergency situation.

In another embodiment, the device further comprises a smoke detector which emits an alarm and/or the detector activates a light so that the device can be found in the dark such as a smoke-filled room. The alarm would be operational via an internal battery.

In a further embodiments, the devices comprise a glass breaking component comprised of at least one hardened, sharp and heavy carbon steel point capable of breaking out through a car window in an emergency.

In further embodiments, the devices further comprise a razor-sharp stainless steel seat belt cutter configured to cut a seat belt completely through.

In further embodiment, the device has a lighting component, such as for example. LEDs, which can be turned on and uses as a flashlight to aid in escaping the emergency.

The device is configured for one use only. After one use, the cylinder is discarded and replaced by a new cylinder so that the device will always be fully charged.

In embodiments which require electric power, such power is supplied by a non-rechargeable battery so that the size and weight of the device can be kept manageable.

The devices of the current disclosure are further comprised of a container containing the cylinder with the compressed gas, the mask-less mouth delivery component and the activator. The container may be metal, plastic or other materials well known in the art for the construct of a container. The container is additionally configured to contain the peripheral components mentioned above, such as, batteries, LED lighting, smoke detector, glass breaker, and seat belt cutter.

The cylinder is in communication with the mouth either directly or by way of other components such as, for example, an actuator.

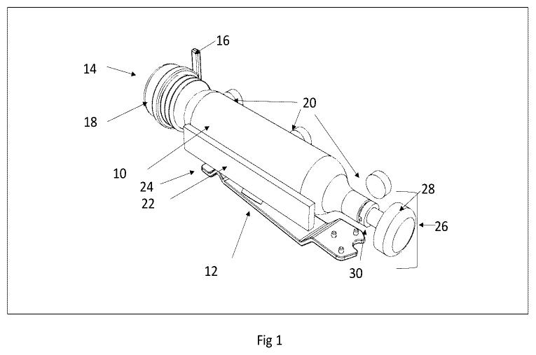

Turning now to the Figures: FIG. 1 shows one embodiment of the current disclosure. The figure shows a cylinder of compressed, breathable gas 10 situated on a container bracket 12. At one end of the cylinder is positioned a glass breaking component 14, a pull tab 16 which allows access to the mask-less mouth delivery component (not shown) which is situated in front of the glass breaking component accessible by unscrewing 18 the glass breaking component. Also shown are other suitable components, magnets 20 for removably attaching the device to a metal panel, an LED light 22, and a battery and battery holder 24. At the other end of the device is an actuator 26 which contains a push button 28 which, when pressed, allows the compressed air to be released from the cylinder 10 to the mask-less mouth delivery component (not shown). The actuator contains a return spring 30 which closes the air released when the user releases the button thereby allowing the user to receive the breathable gas on demand and preserving the breathable air until the next time the user chooses to receive the gas.

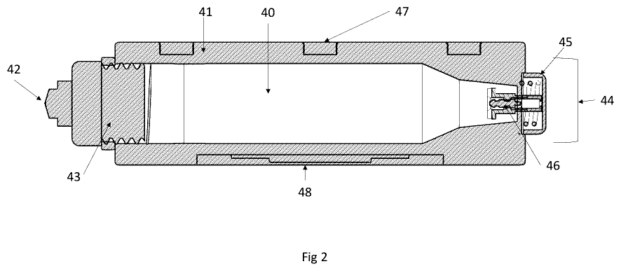

FIG. 2 shows a cross-section of one embodiment of the device containing a gas cylinder 40 which is positioned inside a holder/container 41, a glass breaking component 42, a removable cap 43, an air release valve 44 which contains an air release push button 45 and a return spring 46 which closes the air release button. Also shown are other suitable components, magnets 47 for removably attaching the device to a metal panel and an LED light 48 for enhanced visibility.

The current device is configured to be held in the hand during use. It is not meant to be held in the mouth as weight can be an issue and can drop out of the mouth and not retrievable depending on where the mouth-held device falls.

The device is configured to require no complicated mechanisms to control air release, pulses, flow timing, programming and the like, (each mechanism contributes to the complication, weight, expense, size, possible malfunctions) but merely a push button that releases the gas when pushed and stops gas flow when not pushed. User has complete control the whole time it is in use.

What is claimed is:

1. A breathing device for use in emergencies, comprising:
a. a cylinder filled with compressed, breathable, gas, suitable for between 6-10 full breaths, wherein the cylinder is a disposable, non-refillable cylinder,
b. a mask-less mouth delivery component in communication with the cylinder configured to be inserted into the mouth of the user when in use, and
c. a component for selectively permitting breathable gas-flow from the cylinder through the mouth delivery component to the target user,
wherein the device is configured to be handheld and portable when in use.

2. The device of claim 1 wherein the component for selectively permitting breathable gas-flow is an actuator configured to release a flow of breathable gas from the cylinder to and through the mouth delivery component when engaged and to stop the flow of breathable gas when the activator is disengaged.

3. The device of claim 2 wherein the breathable gas is comprised of between 21% oxygen and 100% medical grade oxygen.

4. The device of claim 2, further comprising a container containing the cylinder with the compressed gas, the mask-less mouth delivery component and the activator.

5. The device of claim 4, further comprising at least one battery-powered LED light configured to illuminate the surroundings of a user, a battery powered smoke detector, a battery compartment to house a battery, a belt clip configured to carry the device on a user's clothing, one or more magnets configure to allow the device to be mounted on metal, a glass breaking component comprised of at least one hardened, sharp and heavy carbon steel point capable of breaking out through a car window in an emergency, or a razor-sharp stainless steel seat belt cutter configured to cut a seat belt completely through, or any combination thereof.
